(19) United States
(12) Patent Application Publication
(10) Pub. No.: US 2020/0166634 A1
(43) Pub. Date: May 28, 2020

(54) Method and System for Weapon Detection

(71) Applicant: Carmi Toni Peleg, Cleveland, GA (US)

(72) Inventor: Carmi Toni Peleg, Cleveland, GA (US)

(21) Appl. No.: 16/199,224

(22) Filed: Nov. 26, 2018

(51) Int. Cl. G01S 13/88; G01S 13/04; G06K 9/62

(52) U.S. Cl. CPC G01S 13/887; G06K 9/628; G01S 13/04

(57) ABSTRACT

A method for weapon detection that includes three radio transceivers, a reference transceiver and a processor. The method includes the following steps: Emitting waves by the radio transceivers in three different frequencies in different intensities and analyzing the returned waves by the processor for determining configurations of objects that detected in the examined zone. Transmitting reference waves by the reference transceiver using the difference between the reference returned waves to the returned waves as a parameter for cleaning noises. Identifying areas in configuration of detected objects that includes mainly returned wave of same values and considering said areas as of a same values and material. Comparing the configuration of the detected objects with weapon configurations database stored in the processor.

### TECHNICAL FIELD

The present invention refers to a method and system for weapon detection based on radio waves.

### BACKGROUND ART

Systems for detecting concealed weapons carried by people in the entrances zone of schools, clubs, restaurant and the like may reduce cases of shooting at innocent civilians. Indeed, there are known theories about weapon detection systems that are based on radio waves for detecting weapons carried by a person. However, these theories are not practical due to the fact that they are likely to have high rate of false detections, that may mainly occur when inspecting zone in a distance of few meters, for example the entrance plaza of a school building. The present invention provides a method and system for weapon detection that reduces the likelihood of false detections outputs.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a schematic illustration of the system (1) that includes three radio transmitter (10), three Radio receivers (40) and a processor (50).

FIG. 2 is a schematic illustration of the system (1) that includes three Radio transceivers 1040, three antennas 2030 and a processor (50).

### THE INVENTION

The main object of the present patent application is to provide a method and a system (1) for weapon detection based on radio waves. The system is designed to create more accurate configurations of the objects in the examined zone and by that to provide better and high detection accuracy. For achieving better detection accuracy the system includes several innovative aspects.

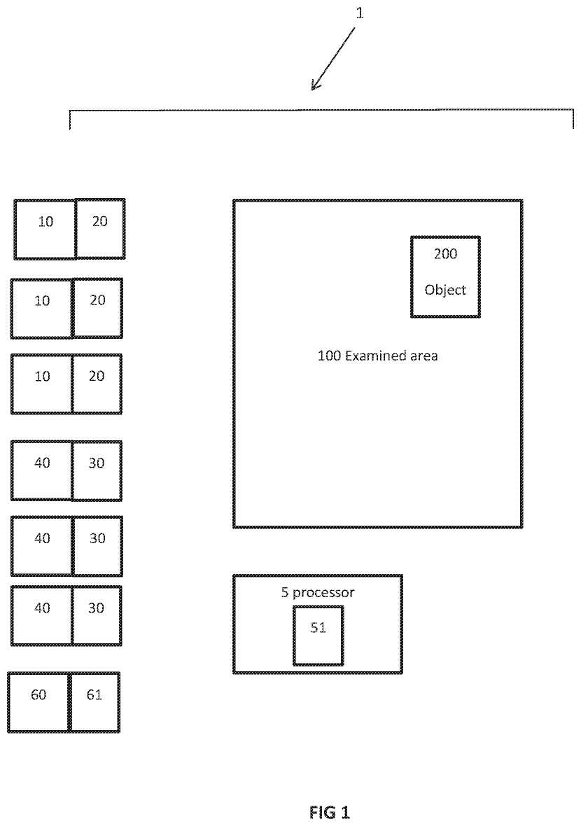

The system (1) includes at least three radio transmitters (10), which are designed to produce electromagnetic waves in the radio or microwaves domain. Each radio transmitter (10) includes a transmitting antenna (20) which is design to transmit the electromagnetic waves. The system also includes at least three radio receivers (40) that each of them includes a receiving antenna (30) that is designed to receive the returned electromagnetic waves. The system also includes a processor (50) for determining the returned waves and the properties of the objects that are identify. FIG. 1 is a schematic illustration of the system (1) that includes three radio transmitter (10), three radio receivers (40) and a processor (50).

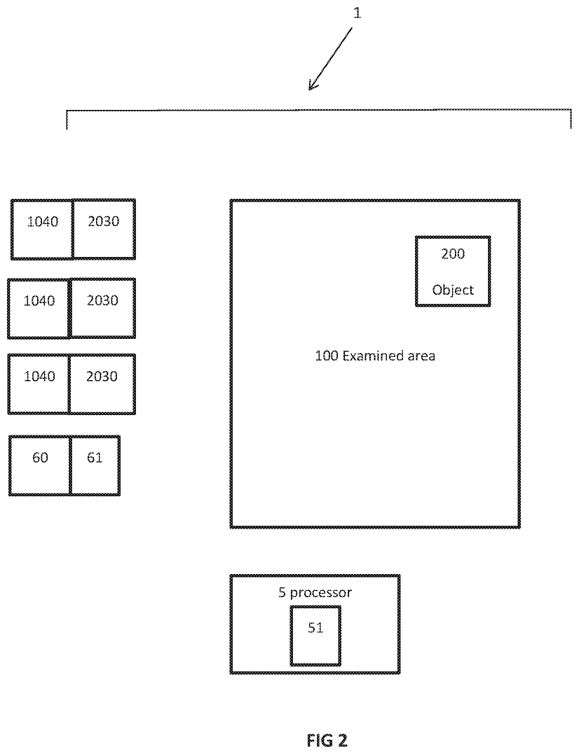

The radio transmitters (10) can be combined with the radio receivers (40) (hereinafter “radio transceivers 1040”) and accordingly the transmitting antenna (20) and the receiving antenna (30) may be the same antenna for transmitting and receiving the electromagnetic waves (hereinafter “antenna 2030”). FIG. 2 is a schematic illustration of the system (1) that includes three radio transceivers 1040, three antennas 2030 and a processor (50).

The knowledge about systems for detecting weapons by radio waves is known to ordinary experts in the field, including the components of such systems, their functions and the ways that they operate. Also it is known and understood to ordinary experts in the filed how processors analyze the returning waves and conclude whether certain objects are actually weapons. Therefore these aspects of the system (1) will not be detailed beyond the necessity.

When implementing the concept of identifying weapons at distances of few meters by radio waves, such systems are inaccurate, give high rate of false alarms and in general do not have detecting quality. The method and the system (1) subject matter of the present invention disclose unique structure and steps that improve its accuracy, mainly, accuracy of analyzing the configuration of the objects in the zone.

The system (1) includes at least three or more radio transceivers (1040) that operate in parallel at the same time and that each of them operates in at least three different frequencies that are constantly changed and in varied intensities and also in varied amplitude. As a result, the system receives a high density data set that enables the system to identify the configuration of the objects in the examined area with better accuracy. In other words, the system receives many configurations of each object located in the examined zone.

It is known that each kind of material has a unique returned wave intensity and by that the system creates a virtual map that may ‘show’ the human body of the person that is located in the examined zone (100) and the objects that this person carries or in his or her bag. The processor (50) of the system ‘translate’ the returned waves to ‘dots’ each of which has numerical value and these dots and their values creates the map of the objects (200) in the examined zone and illustrating their accurate configurations.

The fact that the system includes three radio transceivers (1040) that operate in parallel at the same time, in three different frequencies that are constantly changed and with several changing intensities and amplitudes provide more data set that enable to make better accurate configuration. For example: when transmitting in a specific frequency each time in several intensities, the map is likely to show different configurations per each intensity and the average of such configurations provides more accurate configuration of the object. The same is when transmitting different frequencies that the average of their results provides more accurate configuration, and the same is when changing the amplitudes of the waves. The system may receive dozens and even hundreds of different configurations and their average provides better configurations of the real object.

The method also includes the following steps which are performed by the processor: Identifying areas that mainly includes the same returned wave values. Identifying inner areas inside said identified areas which include different returned wave values. Giving to said inner areas the same values as of the identified areas and whereby gives to the identified area a uniform identity. The starting point is that if there is an area that has a value of a particular returned wave, then if there are returned waves in a different value within said identified areas, we consider them as an error and the system turns the entire area into an area of uniform material. The reference to each identified area in a uniform manner according to most of the frequency returned waves creates a better and more precise identification of the configuration of the objects.

The system (1) also includes a reference transceiver (60) that is equipped with a reference antenna (61). As it is understood, the radio transceivers (1040) transmit the electromagnetic wave in few certain frequencies and naturally they receive the returned waves with ‘noises’. In order to clean the signals received, the reference transceiver (60) transmits the same frequencies as the radio transceivers (1040) but receives the returned wave signal in a very clean manner. The difference between the returned signals in the radio transceivers (1040) and in the reference transceiver (60) is used as a parameter to clean up the signals received in the radio transceivers (1040), and by that enabling to identify the configuration of the objects in the examined area with better accuracy.

As a result of those innovative aspects of the system and the method, the system creates more accurate configuration of the objects in the examined area and consequently enabling better accurate identification of these objects by comparing them to weapon configurations database (51) stored in the processor.

In summary, the present invention refers to a method for weapon detection that comprises the following components and steps:

(a) At least three radio transceivers wherein each of them equipped with antenna, which is designed to transmit electromagnetic waves and to receive returned electromagnetic waves.
(b) A reference transceiver that is equipped with reference antenna, which is designed to transmit reference electromagnetic waves and to receive reference returned electromagnetic waves.
(c) A processor.
(d) Emitting electromagnetic waves by the three radio transceivers to an examined zone at the same time in at least three different frequencies in at least two intensities and in a least two amplitudes.
(e) Transmitting reference electromagnetic waves by the reference transceiver to the examined zone.
(f) Analyzing the returned electromagnetic waves received in the three radio transceivers by the processor for determining configurations of objects that detected in the examined zone.
(g) Using the difference between the references returned electromagnetic waves to the returned electromagnetic waves as a parameter for cleaning noises in the returned electromagnetic waves.
(h) Identifying areas in configuration of detected objects that includes at least eighty percent returned electromagnetic wave at a same values and considering said areas as of a same values and material.
(i) By that the system improves the identification of configuration of the detected objects; and
(j) Comparing the configuration of the detected objects with weapon configurations database stored in the processor.

The present invention refers also to a system for weapon detection that comprises the following components and features:

(a) At least three radio transceivers wherein each of them equipped with antenna, which is designed to transmit electromagnetic waves and to receive returned electromagnetic waves.
(b) A reference transceiver that is equipped with reference antenna, which is designed to transmit reference electromagnetic waves and to receive reference returned electromagnetic waves.
(c) A processor.
(d) Emitting electromagnetic waves by the three radio transceivers to an examined zone at the same time in at least three different frequencies in at least two intensities and in a least two amplitudes.
(e) Transmitting reference electromagnetic waves by the reference transceiver to the examined zone.
(f) Analyzing the returned electromagnetic waves received in the three radio transceivers by the processor for determining configurations of objects that detected in the examined zone.
(g) Using the difference between the references returned electromagnetic waves to the returned electromagnetic waves as a parameter for cleaning noises in the returned electromagnetic waves.
(h) Identifying areas in configuration of detected objects that includes at least eighty percent returned electromagnetic wave at a same values and considering said areas as of a same values and material.
(i) By that the system improves the identification of configuration of the detected objects; and
(j) Comparing the configuration of the detected objects with weapon configurations database stored in the processor.

What is claimed is:

1. A method for weapon detection, comprising:
(a) providing at least three radio transceivers wherein each of said at least three radio transceivers equipped with antenna, said antenna is designed to transmits electromagnetic waves and to receive returned electromagnetic waves;
(b) providing a reference transceiver that is equipped with reference antenna, said reference antenna is designed to transmits reference electromagnetic waves and to receive reference returned electromagnetic waves;
(c) providing a processor;
(d) emitting electromagnetic waves by the at least three radio transceivers to an examined zone at the same time in at least three different frequencies in at least two intensities and in at least two amplitudes;
(e) transmitting reference electromagnetic waves by the reference transceiver to the examined zone;
(f) analyzing the returned electromagnetic waves received in the at least three radio transceivers by the processor for determining configurations of objects that detected in the examined zone;
(g) using the difference between the reference returned electromagnetic waves to the returned electromagnetic waves as a parameter for cleaning noises in said returned electromagnetic waves;
(h) identifying areas in configuration of detected objects that includes at least eighty percent returned electromagnetic wave at a same values and considering said areas as of a same values and material; and
(j) comparing said configuration of said detected objects with weapon configurations database stored in the processor.
whereby improving an identification of configuration of said detected objects;

2. A system for weapon detection, comprising: at least three radio transceivers that each of them equipped with antenna, which is designed to transmit electromagnetic waves and to receive returned electromagnetic waves, a reference transceiver that is equipped with reference antenna, which is designed to transmit reference electromagnetic waves and to receive reference returned electromagnetic waves and a processor;
wherein said at least three radio transceivers are designed to emit electromagnetic waves to an examined zone at the same time in at least three different frequencies in at least two intensities and in a least two amplitudes;
wherein said reference transceiver is designed to transmit reference electromagnetic waves to the examined zone;
wherein said processor is designed to analyze the returned electromagnetic waves received in the three radio transceivers and to determine configurations of objects that detected in the examined zone;
wherein said processor is designed to use the difference between the references returned electromagnetic waves to the returned electromagnetic waves as a parameter for cleaning noises in the returned electromagnetic waves;
wherein said processor is designed to identifies areas in configuration of detected objects that includes at least eighty percent returned electromagnetic wave at a same values and considering said areas as of a same values and material;
wherein said processor is designed to compare the configuration of the detected objects with weapon configurations database stored in the processor; and
whereby improves the identification of configuration of the detected objects.
